(19) United States
(12) Patent Application Publication
(10) Pub. No.: US 2025/0253068 A1
(43) Pub. Date: Aug. 7, 2025

(54) WIRE, STRANDED WIRE, CABLE, AND METHOD OF MANUFACTURING WIRE

(71) Applicant: SUMITOMO ELECTRIC INDUSTRIES, LTD., Osaka (JP)

(72) Inventors: Akiko INOUE, Osaka (JP); Tooru TANJI, Osaka (JP); Ryota MATSUGI, Osaka (JP); Tetsuya KUWABARA, Osaka (JP); Yuya NAMIKI, Osaka (JP); Yoshiaki OTAKE, Tochigi (JP); Masamichi NIWATA, Tochigi (JP); Yuji OCHI, Osaka (JP)

(73) Assignee: SUMITOMO ELECTRIC INDUSTRIES, LTD., Osaka (JP)

(21) Appl. No.: 18/856,318

(22) PCT Filed: Apr. 6, 2023
(86) PCT No.: PCT/JP2023/014175

§ 371 Date: Oct. 11, 2024

(30) Foreign Application Priority Data
Apr. 19, 2022 (JP) 2022-069119

(51) Int. Cl. H01B 1/02; C22C 5/06; C22C 30/00; H01B 7/18; H01B 13/00; H01B 13/008

(52) U.S. Cl. CPC H01B 1/02; C22C 5/06; C22C 30/00; H01B 7/18; H01B 13/0016; H01B 13/0036; H01B 13/008

(57) ABSTRACT

A wire includes: a core; and a shell that covers an outer periphery of the core, wherein the core includes silver, the shell includes 33.0 mass % or more and 37.0 mass % or less of nickel, 9.0 mass % or more and 10.5 mass % or less of molybdenum, 19.0 mass % or more and 21.0 mass % or less of chromium, 0.5 mass % or more and 1.2 mass % or less of titanium, and a remainder including cobalt and an inevitable impurity, a diameter of the wire is 100 μm or less, and an elongation of the wire is 12% or more.

### TECHNICAL FIELD

The present disclosure relates to a wire, a stranded wire, a cable, and a method of manufacturing the wire. The present application claims priority based on Japanese Patent Application No. 2022-069119 filed on Apr. 19, 2022. The entire contents of the Japanese Patent Application are incorporated herein by reference.

### BACKGROUND ART

PTL 1 discloses a wire including a core and a shell that has a tubular shape and that covers an outer periphery of the core. The core is composed of silver. The shell is composed of an alloy including nickel, cobalt, molybdenum and chromium.

### CITATION LIST

### Patent Literature

PTL 1: U.S. Pat. No. 7,015,392

### SUMMARY OF INVENTION

A wire according to the present disclosure includes: a core; and a shell that covers an outer periphery of the core, wherein
the core includes silver,
the shell includes
   33.0 mass % or more and 37.0 mass % or less of nickel,
   9.0 mass % or more and 10.5 mass % or less of molybdenum,
   19.0 mass % or more and 21.0 mass % or less of chromium,
   0.5 mass % or more and 1.2 mass % or less of titanium, and
   a remainder including cobalt and an inevitable impurity,
a diameter of the wire is 100 μm or less, and
an elongation of the wire is 12% or more.

A stranded wire according to the present disclosure has a structure in which a plurality of the wires of the present disclosure are twisted together.

A cable according to the present disclosure include:
the stranded wire according to the present disclosure; and
a sheath that covers an outer periphery of the stranded wire.

A method of manufacturing a wire according to the present disclosure includes:
producing a wire material by fitting a core material and a shell material;
performing wire drawing onto the wire material; and
performing heat treatment onto the wire material having been through the wire drawing, wherein
in the performing wire drawing, intermediate heat treatment is performed at a temperature of 850° C. or more and 960° C. or less for less than 2 hours during the wire drawing performed a plurality of times, and the intermediate heat treatment is performed 20 times or less.

### BRIEF DESCRIPTION OF DRAWINGS

FIG. 1 is a schematic cross sectional view showing a transverse cross section of a wire according to an embodiment.

FIG. 2 is a diagram illustrating a method of manufacturing the wire according to the embodiment, and is a schematic view showing an example of a step of manufacturing a wire material.

FIG. 3 is a schematic cross sectional view showing a transverse cross section of a cable according to the embodiment.

FIG. 4 is a diagram showing an SEM image as observing a longitudinal cross section of a wire of a sample A.

FIG. 5 is a diagram showing an SEM image as observing a vicinity of an outer peripheral surface of a shell in the longitudinal cross section of the wire of sample A.

FIG. 6 is an enlarged SEM image of a region of a portion of the outer peripheral surface of the shell shown in FIG. 5.

FIG. 7 is a diagram showing an SEM image as observing a longitudinal cross section of a wire of a sample B.

FIG. 8 is a diagram showing an SEM image as observing a vicinity of an outer peripheral surface of a shell in the longitudinal cross section of the wire of sample B.

FIG. 9 is a diagram showing an SEM image in which a region of a portion of the outer peripheral surface of the shell shown in FIG. 8 is enlarged.

### DETAILED DESCRIPTION

### Problem to be Solved by the Present Disclosure

The above-described wire is used for medical devices. This wire for the medical purpose is applied to a catheter or the like. Since the diameter of such a catheter has been reduced in recent years, it has been desired to attain a reduced diameter of the wire used in the catheter.

Basic properties required for the wire are high elongation and high tensile strength. In order to reduce the diameter of the wire, processing has to be performed repeatedly until the diameter of the wire becomes a predetermined diameter. Since the wire undergoes work-hardening due to the repeated processing, the elongation is decreased. Therefore, a wire having a small wire diameter and an excellent elongation property has been required.

One object of the present disclosure is to provide a wire having a small wire diameter and an excellent elongation. Another object of the present disclosure is to provide a stranded wire and a cable, each of which has a small diameter and flexibility.

### Advantageous Effect of the Present Disclosure

The wire of the present disclosure has a small wire diameter and an excellent elongation. Each of the stranded wire and the cable of the present disclosure has a small diameter and flexibility.

### Description of Embodiments

First, embodiments of the present disclosure will be listed and described.

(1) A wire according to an embodiment of the present disclosure includes: a core; and a shell that covers an outer periphery of the core, wherein
the core includes silver,
the shell includes
   33.0 mass % or more and 37.0 mass % or less of nickel,
   9.0 mass % or more and 10.5 mass % or less of molybdenum,
   19.0 mass % or more and 21.0 mass % or less of chromium,
   0.5 mass % or more and 1.2 mass % or less of titanium, and
   a remainder including cobalt and an inevitable impurity,
a diameter of the wire is 100 μm or less, and
an elongation of the wire is 12% or more.

The wire has a diameter of 100 μm or less and therefore has a small wire diameter. The wire has an elongation of 12% or more and therefore has an excellent elongation. Therefore, the wire has a small wire diameter and an excellent elongation.

Since the core includes silver, the wire has electric conductivity. The core may be composed of silver and an inevitable impurity, or may be composed of an alloy including silver such as a silver alloy. The above-described specific cobalt alloy, which includes nickel, molybdenum, chromium, and titanium, has excellent mechanical properties. Since the shell is composed of the specific cobalt alloy, the wire has both a high tensile strength and a high elongation.

(2) In the wire of the present disclosure according to (1), in a transverse cross section of the wire, a ratio of a cross sectional area of the shell to a cross sectional area of the wire may be 50% or more and 90% or less.

The wire of the above-described embodiment has excellent electric conductivity, tensile strength, and elongation.

(3) The wire of the present disclosure according to (1) or (2) may include a precipitation layer including a titanium precipitate in an outer peripheral surface of the shell, wherein
a thickness of the precipitation layer may be 0.1 μm or more and 1.0 μm or less.

With the wire of the above-described embodiment, decrease in elongation can be suppressed. As will be described later in detail, the present inventors have found that the decrease in elongation of the wire can be significantly suppressed by controlling the thickness of the precipitation layer to fall within the above-described specific range. For example, by setting the thickness of the precipitation layer to fall within the above-described specific range, the elongation of the wire can be 12% or more.

(4) In the wire of the present disclosure according to any one of (1) to (3), an average crystal grain size of a metal of the shell in a longitudinal cross section of the wire may be 0.1 μm or more and 5.0 μm or less.

The wire of the above-described embodiment has a high tensile strength.

(5) In the wire of the present disclosure according to any one of (1) to (4), a tensile strength of the wire may be 600 MPa or more.

The wire of the above-described embodiment has an excellent tensile strength.

(6) The wire of the present disclosure according to any one of (1) to (5) may include an insulating layer that covers an outer periphery of the shell.

In the wire of the above-described embodiment, insulation from a member therearound can be secured by the insulating layer.

(7) A stranded wire according to an embodiment of the present disclosure includes a structure in which a plurality of the wires according to any one of (1) to (6) are twisted together.

The stranded wire of the present disclosure is formed by twisting the wires of the present disclosure, and therefore has a small diameter and flexibility.

(8) A cable according to an embodiment of the present disclosure includes:
the stranded wire according to (7); and
a sheath that covers an outer periphery of the stranded wire.

Since the cable of the present disclosure includes the stranded wire of the present disclosure, the cable has a small diameter and flexibility.

(9) The cable of the present disclosure according to (8) may include a shielding layer between the stranded wire and the sheath.

In the cable of the above-described embodiment, an electromagnetic wave can be shielded by the shielding layer.

(10) A method of manufacturing the wire according to (1) includes:
producing a wire material by fitting a core material and a shell material;
performing wire drawing onto the wire material; and
performing heat treatment onto the wire material having been through the wire drawing, wherein
in the performing wire drawing, intermediate heat treatment is performed at a temperature of 850° C. or more and 960° C. or less for less than 2 hours during the wire drawing performed a plurality of times, and the intermediate heat treatment is performed 20 times or less.

With the above-described method of manufacturing the wire, a wire having a small wire diameter and an excellent elongation can be provided.

### Details of Embodiments of Present Disclosure

Hereinafter, an embodiment of the present disclosure will be specifically described with reference to figures. The same reference characters in the figures represent objects having the same names.

It should be noted that the present invention is defined by the terms of the claims, rather than these illustrated examples, and is intended to include any modifications within the scope and meaning equivalent to the terms of the claims.

### <Wire>

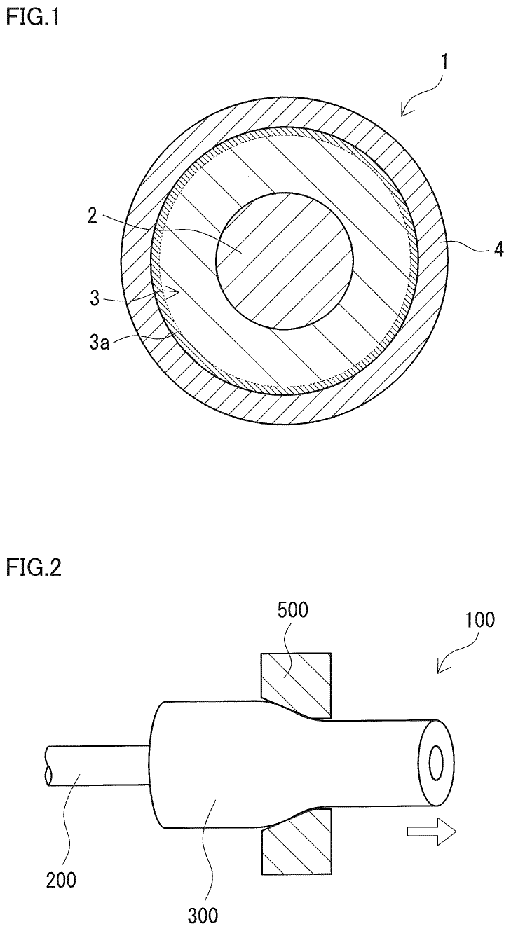

A wire 1 according to an embodiment will be described with reference to FIG. 1. Wire 1 includes a core 2 and a shell 3. Each of core 2 and shell 3 is composed of a metal. The diameter of wire 1 is 100 μm or less. The elongation of wire 1 is 12% or more. Hereinafter, wire 1 will be described in detail.

In the following description, elements are represented by symbols of elements. Ag is silver. Co is cobalt. Ni is nickel. Mo is molybdenum. Cr is chromium. Ti is titanium. C is carbon. P is phosphorus. Si is silicon. Mn is manganese. S is sulfur. Fe is iron. Cu is copper. Al is aluminum.

### <Shape>

The shape of wire 1 can be appropriately selected. Wire 1 of the present embodiment is a round wire. The shape of a transverse cross section of wire 1 is a circular shape as shown in FIG. 1. The transverse cross section is a cross section taken along a plane orthogonal to a long-side direction of wire 1. The shape of the transverse cross section of wire 1 may be a non-circular shape. The non-circular shape is, for example, a polygonal shape, an elliptic shape, or the like. The polygonal shape is, for example, a rectangular shape, a hexagonal shape, or the like. The rectangle shape includes a square shape.

### <Diameter>

The diameter of wire 1 is 100 μm or less. The term “diameter” as used herein means the diameter of wire 1 in the transverse cross section. When the shape of the transverse cross section of wire 1 is a non-circular shape, the diameter of wire 1 is the diameter of a circle having an area equal to the area of the transverse cross section of wire 1. The diameter of wire 1 is more preferably 80 μm or less or 60 μm or less. Wire 1 having a diameter of 100 μm or less can be suitably used for a medical device such as a catheter, for example. The lower limit of the diameter of wire 1 is not particularly limited, but is, for example, 10 μm. The diameter of wire 1 is, for example, 10 μm or more and 100 μm or less, 15 μm or more and 80 μm or less, or 20 μm or more and 60 μm or less.

### <Elongation>

The elongation of wire 1 is 12% or more. The term “elongation” as used herein means breaking elongation when wire 1 is broken by pulling wire 1 at a certain rate using a tensile tester. The elongation may be measured in accordance with JIS Z 2241:2011 “Metallic materials-Tensile testing-Method of test at room temperature”. The elongation of wire 1 is more preferably 13% or more or 15% or more. In particular, when the elongation of wire 1 is regarded as being important, the elongation may be 17% or more or 20% or more. The upper limit of the elongation of wire 1 is not particularly limited, but is, for example, 30%. The elongation of wire 1 is, for example, 12% or more and 30% or less, 13% or more and 27% or less, or 15% or more and 25% or less.

### <Tensile Strength>

The tensile strength of wire 1 is preferably 600 MPa or more. The term “tensile strength” as used herein means a breaking strength when wire 1 is broken by pulling wire 1 at a certain pulling rate using a tensile tester. The tensile strength may be measured in accordance with JIS Z 2241:2011 “Metallic materials-Tensile testing-Method of test at room temperature”. The tensile strength of wire 1 may be 700 MPa or more or 800 MPa or more. The upper limit of the tensile strength of wire 1 is not particularly limited, but is, for example, 1300 MPa. The tensile strength of wire 1 is, for example, 600 MPa or more and 1300 MPa or less, 700 MPa or more and 1250 MPa or less, or 800 MPa or more and 1200 MPa or less.

### <Electric Conductivity>

The electric conductivity of wire 1 is preferably 10% IACS or more. The electric conductivity of wire 1 may be 20% IACS or more, or 25% IACS or more. In particular, when the electric conductivity of wire 1 is regarded as being important, the electric conductivity may be 30% IACS or more, or 35% IACS or more. The upper limit of the electric conductivity of wire 1 is not particularly limited, but is, for example, 60% IACS. The electric conductivity of wire 1 is, for example, 10% IACS or more and 60% IACS or less, 20% IACS or more and 20% IACS or less, or 25% IACS or more and 55% IACS or less.

### (Core)

Core 2 may be composed of Ag. The expression “core 2 is composed of Ag” means that the metal of core 2 contains 95 mass % or more, further 97 mass % or more, particularly 99 mass % or more, or 99.9 mass % or more of Ag. Core 2 may be composed of an Ag alloy including Ag. Such an Ag alloy is considered to contain, for example, 90 mass % or more of Ag. Core 2 is disposed at the center of wire 1 as shown in FIG. 1. Core 2 is a portion that mainly secures the electric conductivity of wire 1. Core 2 has a higher electric conductivity than that of shell 3. Wire 1 has electric conductivity because wire 1 includes core 2. As the area of the transverse cross section of core 2 is larger, electric resistance becomes smaller, thus resulting in high electric conductivity of wire 1. A degree of contribution of core 2 to the strength of wire 1 is lower than a degree of contribution of shell 3 thereto.

Core 2 is constituted of a single wire. In the present embodiment, the shape of the transverse cross section of core 2 is a circular shape. The shape of the transverse cross section of core 2 is not particularly limited. The shape of the transverse cross section of core 2 may be a non-circular shape.

### (Shell)

Shell 3 includes a specific Co alloy. As shown in FIG. 1, shell 3 covers an outer periphery of core 2. Shell 3 has a pipe shape. Shell 3 is joined to core 2. That is, shell 3 is in direct contact with core 2. Shell 3 is a portion that mainly secures the strength of wire 1. Shell 3 has a higher strength than that of core 2. Wire 1 has a high tensile strength because wire 1 includes shell 3. As the area of the transverse cross section of shell 3 is larger, the tensile strength of wire 1 is higher. A degree of contribution of shell 3 to the electric conductivity of the wire is lower than a degree of contribution of core 2 thereto.

In the present embodiment, the shape of the transverse cross section of shell 3 is an annular shape. That is, in the transverse cross section of shell 3, the shape of the contour of each of the inner periphery and outer periphery of shell 3 is a circular shape. The shape of the transverse cross section of shell 3 is not particularly limited. At least one of the contours of the inner periphery and outer periphery of shell 3 may be a non-circular shape. The contour of the inner periphery of shell 3 and the contour of the outer periphery of shell 3 may have the same shape or different shapes.

Shell 3 includes Ni, Mo, Cr, Ti, and a remainder including Co and an inevitable impurity. The remainder may be constituted of Co and the inevitable impurity. The content of Ni is 33.0 mass % or more and 37.0 mass % or less. The content of Mo is 9.0 mass % or more and 10.5 mass % or less. The content of Cr is 19.0 mass % or more and 21.0 mass % or less. The content of Ti is 0.5 mass % or more and 1.2 mass % or less. Examples of the inevitable impurity include C, P, Si, Mn, S, Fe, and the like. The content of the inevitable impurity is, for example, 2.0 mass % or less in total. The Co alloy having such a composition has excellent mechanical properties. Since shell 3 is composed of the above-described specific Co alloy, wire 1 has both a high tensile strength and a high elongation. The specific Co alloy is defined as an F562 alloy in the American Society for Testing and Materials (ASTM) standard. A specific example of the F562 alloy is MP35N (trademark) from SPS Technologies.

### <Ratio of Cross Sectional Area of Shell>

In the transverse cross section of wire 1, a ratio of the cross sectional area of shell 3 to the cross sectional area of wire 1 is preferably 50% or more and 90% or less. The cross sectional area of wire 1 is a sum of the cross sectional area of core 2 and the cross sectional area of shell 3. The ratio of the cross sectional area of shell 3 is a ratio of the cross sectional area of shell 3 when the cross sectional area of wire 1 is assumed as 100%. Therefore, when the ratio of the cross sectional area of shell 3 is 50% or more and 90% or less, the ratio of the cross sectional area of core 2 is 10% or more and 50% or less. Hereinafter, the “ratio of the cross sectional area of the shell” is referred to as “ratio of coverage of the shell”.

The electric conductivity and tensile strength of wire 1 can be controlled by changing the ratio of coverage of shell 3. As the ratio of coverage of shell 3 is larger, the ratio of the cross sectional area of shell 3 in the cross sectional area of wire 1 is increased. Therefore, the tensile strength of wire 1 is likely to be high. When the ratio of coverage of shell 3 is 50% or more, the tensile strength of wire 1 is readily sufficiently secured. As the ratio of coverage of shell 3 is smaller, the ratio of the cross sectional area of shell 3 in the cross sectional area of wire 1 is decreased. That is, the ratio of the cross sectional area of core 2 is increased. Therefore, the electric conductivity of wire 1 becomes high. When the ratio of coverage of shell 3 is 90% or less, the electric conductivity of wire 1 is readily secured. Therefore, when the ratio of coverage is 50% or more and 90% or less, wire 1 excellent in electric conductivity, tensile strength, and elongation can be obtained. The ratio of the cross sectional area of shell 3 may be 55% or more and 85% or less, or 60% or more and 80% or less.

### <Average Crystal Grain Size of Shell>

The average crystal grain size of the metal of shell 3 in a longitudinal cross section of wire 1 is preferably 0.1 μm or more and 5.0 μm or less. The metal of shell 3 is the above-described specific Co alloy. Hereinafter, the “average crystal grain size of the metal of the shell” is referred to as “average crystal grain size of the shell”. As the average crystal grain size of shell 3 is smaller, the strength of shell 3 is improved, thus resulting in a high tensile strength of wire 1. When the average crystal grain size of shell 3 is 5.0 μm or less, wire 1 having a high tensile strength can be obtained. The lower limit of the average crystal grain size of shell 3 is not particularly limited, but is normally 0.1 μm. The average crystal grain size of shell 3 may be 0.15 μm or more and 4.0 μm or less, or 0.2 μm or more and 2.0 μm or less. It should be noted that the average crystal grain size of the metal of shell 3 in the transverse cross section of wire 1 is also the same as the average crystal grain size of the metal of shell 3 in the longitudinal cross section.

The average crystal grain size of shell 3 can be measured as follows. A cross section of shell 3 in the longitudinal cross section of wire 1 is observed with a scanning electron microscope (SEM). The longitudinal cross section is a cross section taken along a plane extending through the center of wire 1 along the long-side direction of wire 1. The length of wire 1 in the longitudinal cross section is, for example, 0.05 mm or more and 0.5 mm or less. An observation visual field is taken from the cross section of shell 3. The observation visual field may be selected from a region in the vicinity of the central portion of shell 3 in the thickness direction. The size of the observation visual field may be set such that 10 or more crystal grains are included in the observation visual field. The size of the observation visual field is, for example, 10 μm×20 μm. The grain sizes of the crystal grains included in the observation visual field are measured. The grain size of each of the crystal grains is regarded as the diameter of a circle having an area equal to the area of the crystal grain. The area of the crystal grain can be found by image processing. The average value of the measured grain sizes of the crystal grains is defined as the average crystal grain size in the observation visual field. In a plurality of different observation visual fields, the grain sizes of the crystal grains are measured in the same manner to find respective average crystal grain sizes. The average value of the average crystal grain sizes in all the observation visual fields is regarded as the average crystal grain size of shell 3. The number of the observation visual fields is, for example, 5 or more.

### (Precipitation Layer)

In the present embodiment, a precipitation layer 3a including Ti precipitates is provided at the outer peripheral surface of shell 3. Precipitation layer 3a is a portion of shell 3. Precipitation layer 3a may be continuously or discontinuously provided along the outer peripheral surface of shell 3. Shell 3 has precipitation layer 3a on the outer peripheral side and has an inner region inside precipitation layer 3a. Typically, an amount of the Ti precipitates in precipitation layer 3a is larger than an amount of the Ti precipitates in the inner region. For example, when the cross section of shell 3 is observed in an observation visual field having a predetermined size, the number of the Ti precipitates included in precipitation layer 3a is larger than the number of the Ti precipitates included in the inner region. In one example, the amount of the Ti precipitates is decreased in a direction from the outer periphery toward the inner region of precipitation layer 3a. In another example, in the observation visual field, the Ti precipitates are dispersed at a relatively high density in precipitation layer 3a, and the Ti precipitates are dispersed at a relatively low density in the inner region. In still another example, in the observation visual field, precipitation layer 3a partially includes a region in which the Ti precipitates are dispersed at a high density. In this case, in the observation visual field, the inner region partially includes a region in which the Ti precipitates are dispersed at a low density, or does not include the Ti precipitates. Each of the Ti precipitates is a secondary phase particle in which Ti is concentrated. The Ti included in the precipitate is originated from the Ti included in the above-described specific Co alloy of shell 3.

As a result of diligent study, the present inventors have obtained the following finding. When Ti is included in the above-described specific Co alloy of shell 3, the Ti may be precipitated in the course of the manufacturing of wire 1 to form precipitation layer 3a in the outer peripheral surface of shell 3. The Ti precipitate in precipitation layer 3a may serve as a starting point of cracking to result in decreased tensile strength and elongation. In particular, when the diameter of wire 1 is 100 μm or less, an influence of precipitation layer 3a on the mechanical properties is large, with the result that the tensile strength and the elongation are likely to be decreased. The present inventors have found that the decrease in each of the tensile strength and the elongation of shell 3 can be significantly suppressed by controlling the thickness of precipitation layer 3a. Specifically, it has been found that it is effective to set the thickness of precipitation layer 3a to 1.0 μm or less in suppressing the decrease of the mechanical properties of wire 1.

The thickness of precipitation layer 3a is preferably 0.1 μm or more and 1.0 μm or less. Here, the thickness of precipitation layer 3a refers to the thickness thereof in the transverse cross section of shell 3 in the radial direction. The thickness of precipitation layer 3a can be considered to be changed along the outer periphery of shell 3, and in this case, the maximum thickness thereof is preferably 0.1 μm or more and 1.0 μm or less. As the thickness of precipitation layer 3a is smaller, a ratio of precipitation layer 3a in shell 3 is decreased. Therefore, the tensile strength and elongation of shell 3 can be suppressed from being decreased. When the thickness of precipitation layer 3a is 1.0 μm or less, wire 1 excellent in tensile strength and elongation can be obtained. The lower limit of the thickness of precipitation layer 3a is not particularly limited, but is, for example, 0.1 μm. The thickness of precipitation layer 3a may be 0.1 μm or more and 0.8 μm or less, or 0.2 μm or more and 0.6 μm or less. A method of measuring the thickness of precipitation layer 3a will be described in Test Examples below.

### (Insulating Layer)

Wire 1 may include an insulating layer 4 as shown in FIG. 1. Insulating layer 4 covers the outer periphery of shell 3. Insulating layer 4 is in direct contact with shell 3. Insulating layer 4 may be provided as required and may not be provided. Insulating layer 4 is composed of a resin having an electric insulation property. The resin of insulating layer 4 is, for example, a polyurethane resin, a polyester resin, a polyester imide resin, a polyamide imide resin, or a polyimide resin. Since wire 1 includes insulating layer 4, electric insulation from a member therearound can be secured by insulating layer 4.

Insulating layer 4 may have a single-layer structure or a multilayer structure with two or more layers. In the present embodiment, insulating layer 4 is composed of a polyester imide resin. Unlike the present embodiment, insulating layer 4 may be composed of two or more layers of different resins.

### <Method of Manufacturing Wire>

Wire 1 of the present embodiment as described above can be manufactured by a manufacturing method including the following first step, second step, and third step.

The first step is a step of producing a wire material by fitting a core material and a shell material.

The second step is a step of performing wire drawing onto the wire material.

The third step is a step of performing heat treatment onto the wire material having been through the wire drawing.

Hereinafter, each step will be described in detail.

### (First Step)

In the first step, the core material in the form of a wire is inserted into the shell material in the form of a pipe, and the core material and the shell material are fitted to each other, thereby producing the wire material. The core material is composed of Ag. The core material will finally become the above-described core 2 in wire 1. The shell material is composed of the above-described specific Co alloy including Ni, Mo, Cr, and Ti. The shell material will finally become the above-described shell 3 in wire 1. The diameter of the core material is, for example, 3 mm or more and 10 mm or less. The inner diameter of the shell material is slightly larger than the diameter of the core material to such an extent that the core material can be inserted thereinto. The outer diameter of the shell material is, for example, 5 mm or more and 35 mm or less. The ratio of coverage of shell 3 in the finally obtained wire 1 is changed depending on the ratio of the area of the transverse cross section of the core material and the area of the transverse cross section of the shell material as well as a processing method employed when fitting the core material and the shell material to each other. The diameter of the core material and the outer diameter of the shell material may be appropriately selected such that the ratio of coverage of shell 3 falls within a predetermined range.

The core material and the shell material can be fitted to each other by, for example, a drawing process or a rotary swaging process. Referring to FIG. 2, the following describes an example in which the core material and the shell material are fitted to each other using the drawing process. In the case of the drawing process, core material 200 inserted in shell material 300 is caused to pass through die 500 and is then drawn, thereby obtaining wire material 100. The shape of the transverse cross section of core material 200 shown in FIG. 2 is a circular shape. The shape of the transverse cross section of shell material 300 is an annular shape. The shape of the transverse cross section of wire material 100 is a circular shape. Core material 200 and shell material 300 are brought into close contact with each other by the drawing process, thereby joining core material 200 and shell material 300 to each other. The diameter of wire material 100 is smaller than the outer diameter of the shell material before the drawing process. The diameter of wire material 100 may be, for example, 4.5 mm or more and 32 mm or less. When the diameter of wire material 100 is large, it is necessary to repeat the wire drawing in the subsequent second step.

### (Second Step)

In the second step, the wire drawing is performed onto the wire material such that the diameter of the wire material becomes a predetermined diameter. The wire drawing is repeated a plurality of times until the diameter of the wire material becomes the predetermined diameter. When the wire drawing is repeated, intermediate heat treatment is performed during the wire drawing performed the plurality of times. This intermediate heat treatment is mainly intended to soften the wire material during the wire drawing so as to improve processability.

The intermediate heat treatment is one of factors for forming precipitation layer 3a described above. As a result of diligent study, the present inventors have found that the thickness of precipitation layer 3a can be suppressed by controlling conditions of the intermediate heat treatment. Specifically, the thickness of precipitation layer 3a can be suppressed by controlling a temperature, a time, the number of times of performing the intermediate heat treatment, and a cooling rate among the conditions of the intermediate heat treatment. In particular, in order to suppress the thickness of precipitation layer 3a, it is effective to appropriately manage the temperature and time of the intermediate heat treatment. The conditions of the intermediate heat treatment may be appropriately selected such that the thickness of precipitation layer 3a becomes 1.0 μm or less. The following describes suitable conditions of the intermediate heat treatment to suppress the thickness of precipitation layer 3a.

The temperature of the intermediate heat treatment is, for example, 850° C. or more and 960° C. or less. When the temperature of the intermediate heat treatment is 850° C. or more, the wire material is readily softened. When the temperature of the intermediate heat treatment is 850° C. or more, the wire material is readily softened in a short time. When the temperature of the intermediate heat treatment is 960° C. or less, the core material composed of Ag can be suppressed from being melted and expanded in volume. Therefore, such a problem that the shell material is broken due to the volume expansion of the core material is unlikely to occur. The temperature of the intermediate heat treatment is preferably 860° C. or more and 950° C. or less, or 880° C. or more and 940° C. or less.

The time of the intermediate heat treatment is, for example, 5 seconds or more and less than 2 hours. The time of the intermediate heat treatment is a time for holding the wire material at the above-described temperature. When the time of the intermediate heat treatment is 1 second or more, the wire material is readily softened. As the time of the intermediate heat treatment is shorter, the thickness of precipitation layer 3a tends to be smaller. When the time of the intermediate heat treatment is less than 2 hours, the thickness of precipitation layer 3a is readily suppressed. The time of the intermediate heat treatment is preferably 10 seconds or more and less than 2 hours, 15 seconds or more and 1.5 hours or less, or 30 seconds or more and 1 hour or less. The time of the intermediate heat treatment is preferably changed depending on the diameter of the wire material. This is due to the following reason: when the diameter of the wire material is large, it takes time to soften the entire wire material. For example, when the diameter of the wire material is 3 mm or more, the time of the intermediate heat treatment is preferably 1 minute or more, and more preferably 10 minutes or more. Further, for example, when the diameter of the wire material is 1 mm or less, the time of the intermediate heat treatment may be less than 1 minute.

The number of times of performing the intermediate heat treatment is, for example, 20 times or less. As the number of times of performing the intermediate heat treatment is smaller, the thickness of precipitation layer 3a tends to be smaller. When the number of times of performing the intermediate heat treatment is 20 times or less, the thickness of precipitation layer 3a is readily suppressed. The number of times of performing the intermediate heat treatment is preferably 15 times or less. The number of times of performing the intermediate heat treatment is, for example, four or more times although it depends on the number of times of performing the wire drawing. The number of times of performing the intermediate heat treatment is preferably 4 times or more and 20 times or less, or 5 times or more and 15 times or less, for example.

After performing the intermediate heat treatment, the wire material is cooled. A cooling rate after the intermediate heat treatment is, for example, 1.5° C./second or more. As the cooling rate is higher, the thickness of precipitation layer 3a tends to be smaller. When the cooling rate is 1.5° C./second or more, the thickness of precipitation layer 3a is readily suppressed. Further, the cooling rate is preferably 10° C./second or more. A higher cooling rate is more preferable. Further, the cooling rate may be 100° C./second or more.

Moreover, an atmosphere of the intermediate heat treatment is preferably an inert gas atmosphere or a reducing gas atmosphere in order to suppress oxidation of the wire material. The inert gas is, for example, argon gas, nitrogen gas, or the like. The reducing gas is, for example, hydrogen gas, carbon monoxide gas, or the like.

### (Third Step)

In the third step, the heat treatment is performed onto the wire material having been through the wire drawing, thereby obtaining the wire. This heat treatment is mainly intended to soften the wire material having been through the wire drawing so as to adjust the mechanical properties of the wire to be finally obtained. This heat treatment is referred to as final heat treatment.

The final heat treatment is also one of the factors for forming precipitation layer 3a as with the intermediate heat treatment. Even when the conditions of the intermediate heat treatment are controlled in the second step such that the thickness of precipitation layer 3a becomes 1.0 μm or less, the thickness of precipitation layer 3a may become more than 1.0 μm depending on conditions of the final heat treatment. Therefore, in order to suppress the thickness of precipitation layer 3a, it is necessary to control not only the conditions of the intermediate heat treatment but also the conditions of the final heat treatment. The following describes suitable conditions of the final heat treatment to suppress the thickness of precipitation layer 3a.

The temperature of the final heat treatment is, for example, 900° C. or more and 950° C. or less. When the temperature of the final heat treatment is 900° C. or more, the elongation of the wire can be improved, thereby obtaining a wire excellent in balance between the tensile strength and the elongation. Since the temperature of the final heat treatment is 950° C. or less, the thickness of precipitation layer 3a is readily suppressed.

The time of the final heat treatment is, for example, 2 seconds or more and 3 minutes or less. The time of the final heat treatment is a time for holding the wire material at the above-described temperature. When the time of the final heat treatment is 2 seconds or more, the elongation of the wire is readily improved. When the time of the final heat treatment is 3 minutes or less, the thickness of precipitation layer 3a is readily suppressed. Further, the time of the final heat treatment is preferably 2 seconds or more and 60 seconds or less, or 4 seconds or more and 30 seconds or less.

As with the intermediate heat treatment, an atmosphere of the final heat treatment is preferably an inert gas atmosphere or a reducing gas atmosphere.

### (Other Step)

When manufacturing wire 1 including insulating layer 4 shown in FIG. 1, in addition to the above-described steps, a fourth step of covering the outer periphery of the wire having been through the final heat treatment with insulating layer 4 may be included after the third step.

### (Fourth Step)

In the fourth step, for example, a resin for insulating layer 4 is applied to the outer periphery of the wire, and then the resin is baked. Thus, as shown in FIG. 1, insulating layer 4 can be formed to cover shell 3 of wire 1. When insulating layer 4 is constituted of two or more layers, resins for the two or more layers may be applied and baked. For example, when forming insulating layer 4 having a two-layer structure, a first resin is applied and baked, and then a second resin different from the first resin is applied and baked.

### <Cable>

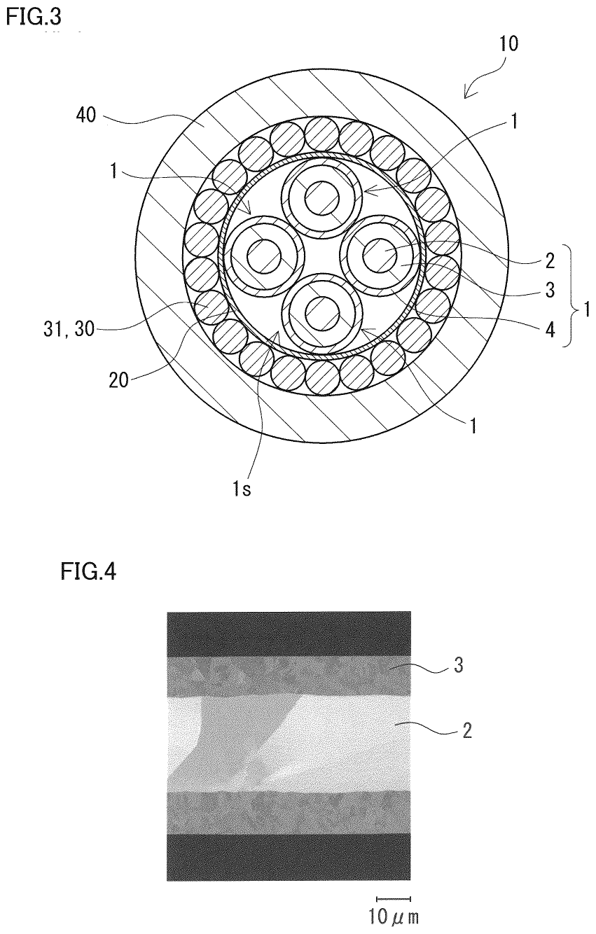

A cable 10 according to the embodiment will be described with reference to FIG. 3. Cable 10 includes a stranded wire is and a sheath 40. Cable 10 of the present embodiment further includes a shielding layer 30.

### (Stranded Wire)

Stranded wire is is formed by twisting a plurality of wires 1. As shown in FIG. 3, stranded wire is of the present embodiment has a structure in which four wires 1 are twisted together. The number of wires 1 included in stranded wire is can be appropriately selected as required. The number of wires 1 may be two, three, or five or more. Stranded wire is may have an interposition between wires 1 twisted together, that is, an interposition that fills a twisting groove. In the present embodiment, the interposition is not provided.

Wire 1 of the present embodiment includes insulating layer 4. Therefore, in stranded wire 1s, electric insulation between wires 1 twisted together can be secured by respective insulating layers 4 of wires 1.

In the present embodiment, a film 20 is wound around stranded wire Is. Film 20 is composed of a resin having an electric insulation property. Film 20 is disposed between stranded wire is and shielding layer 30. Film 20 avoids stranded wire is and shielding layer 30 from being in direct contact with each other, thereby suppressing damage of each of stranded wire is and shielding layer 30.

### (Shielding Layer)

Shielding layer 30 is provided around stranded wire is. Shielding layer 30 is disposed between stranded wire is and sheath 40. Shielding layer 30 is a member that shields an electromagnetic wave. In the present embodiment, shielding layer 30 is formed by arranging a plurality of elemental wires 31 side by side therearound. In shielding layer 30, adjacent elemental wires 31 are arranged side by side therearound in contact with each other. A material of each of elemental wires 31 is, for example, a Cu alloy, an Ag alloy, or an Al alloy. In the present embodiment, elemental wire 31 of shielding layer 30 is composed of a Cu alloy.

### (Sheath)

Sheath 40 covers the outer periphery of stranded wire 1s. In the present embodiment, sheath 40 is provided to cover shielding layer 30. That is, stranded wire is and sheath 40 are not in direct contact with each other. Sheath 40 is a member that mechanically protects stranded wire is. Sheath 40 is composed of a resin, for example. The resin of sheath 40 is, for example, a fluororesin, a polyester resin, or a polyurethane resin. Specific examples of the fluororesin include a polytetrafluoroethylene resin and the like. In the present embodiment, sheath 40 is composed of a fluororesin. Sheath 40 is formed by, for example, extrusion molding.

### Test Examples

Samples of wires each including a core and a shell were produced. The produced samples were evaluated.

The wire of each sample was produced as follows. A wire composed of Ag was prepared as the core material. The shape of the transverse cross section of the core material is a circular shape. A pipe composed of a Co alloy was prepared as the shell material. The Co alloy of the shell material is MP35N, which is commercially available. The shape of the transverse cross section of the shell material is an annular shape. The core material was inserted into the shell material, and the core material and the shell material were fitted to each other, thereby producing the wire material. The core material and the shell material were fitted to each other by using the drawing process. The shape of the transverse cross section of the wire material is a circular shape.

The diameter of the core material used in each of samples No. 1 and No. 11 is 12.2 mm. The inner diameter of the shell material used in each of samples No. 1 and No. 11 is 13.3 mm and the outer diameter thereof is 18.3 mm. The diameter of the core material used in each of samples No. 2, No. 3 and No. 12 is 8.4 mm. The inner diameter of the shell material used in each of samples No. 2, No. 3 and No. 12 is 9.5 mm and the outer diameter thereof is 15.3 mm. The diameter of the core material used in each of samples No. 4, No. 5 and No. 13 is 7.2 mm. The inner diameter of the shell material used in each of samples No. 4, No. 5 and No. 13 is 8.1 mm and the outer diameter thereof is 15.3 mm. The diameter of the core material used in sample No. 6 is 4.5 mm. The inner diameter of the shell material used in sample No. 6 is 5.0 mm and the outer diameter thereof is 14.8 mm. The diameter of the core material used in sample No. 14 is 11.2 mm. The inner diameter of the shell material used in sample No. 14 is 12.0 mm and the outer diameter thereof is 15.3 mm. The diameter of the core material used in sample No. 15 is 4.0 mm. The inner diameter of the shell material used in sample No. 15 is 5.0 mm and the outer diameter thereof is 18.3 mm.

In each of samples No. 1, No. 11, and No. 15, the diameter of the wire material in which the core material and the shell material are fitted is 16 mm. In each of samples No. 2 to No. 6, No. 12, No. 13, and No. 14, the diameter of the wire material is 13.5 mm.

The produced wire material was subjected to the wire drawing until the diameter of the wire material became 0.040 mm, i.e., 40 μm or 0.055 mm, i.e., 55 μm.

The wire drawing was performed in a cold state. The wire drawing was repeated a plurality of times, and the intermediate heat treatment was performed during the wire drawing. After the wire drawing was ended, the wire material was subjected to the final heat treatment. The conditions of the intermediate heat treatment and the final heat treatment were changed among the samples. In the case of each of sample No. 1 and sample No. 15, a condition A shown in Table 1 was used for the conditions of the heat treatment. In the case of each of samples No. 2, No. 3, No. 4, No. 6, and No. 14, a condition B shown in Table 1 was used. In the case of sample No. 5, a condition C shown in Table 1 was used. In the case of sample No. 11, a condition D shown in Table 2 was used. In the case of sample No. 12, a condition E shown in Table 2 was used. In the case of sample No. 13, a condition F shown in Table 2 was used.

Each of conditions A to F shown in Tables 1 and 2 indicates a timing at which the heat treatment was performed, as well as temperature and time of the heat treatment performed. In each condition, the column “Diameter” indicates the diameter of the wire material. The diameter of the wire material before the wire drawing is described at the top in the column “Diameter”. The diameter of the wire material after the wire drawing is described at the bottom in the column “Diameter”. The diameter of the wire material after the wire drawing is 0.05 mm. The column “Diameter” indicates the diameters of the wire material during the wire drawing in the order from the second one from the top. When the diameter of the wire material was the diameter described in the column “Diameter”, the heat treatment was performed at the “Temperature” for the “Time” as shown in the column “Heat Treatment Conditions”. The column “Heat Treatment Conditions” when the column “Diameter” is 0.040 mm or 0.055 mm indicates the conditions of the final heat treatment. In addition to this, the column “Heat Treatment Conditions” indicates the conditions of the intermediate heat treatment. The number of times of performing the intermediate heat treatment in condition A is 10. The number of times of performing the intermediate heat treatment in each of conditions B, C, and F is 9. The number of times of performing the intermediate heat treatment in condition D is 22. The number of times of performing the intermediate heat treatment in condition E is 20.

For example, when the column “Diameter” in condition A is 12.5 mm, it means that the intermediate heat treatment was performed at 900° C. for 1 hour onto the wire material having been through the wire drawing to have a diameter of 12.5 mm. When the column “Diameter” in condition A is 0.20 mm, it means that the intermediate heat treatment was performed at 920° C. for 15 seconds onto the wire material having been through the wire drawing to have a diameter of 0.20 mm. When the column “Diameter” in condition B is 0.055 mm, it means that the final heat treatment was performed for 7 seconds in a temperature range of 900° C. to 940° C. onto the wire material having been through the wire drawing.

It should be noted that the heat treatment for 0.5 hour or more, i.e., 30 minutes or more was performed using a batch furnace. The heat treatment for less than 0.5 hour, i.e., less than 30 minutes was performed using a continuous softening furnace. An atmosphere of the heat treatment was an inert gas atmosphere or a reducing gas atmosphere.

TABLE 1

| A | | | | B | | | | C | | | |
|---|---|---|---|---|---|---|---|---|---|---|---|
| | Heat Treatment | | | | Heat Treatment | | | | Heat Treatment | | |
| Diameter | Conditions | | | Diameter | Conditions | | | Diameter | Conditions | | |
| (mm) | Temperature | Time | | (mm) | Temperature | Time | | (mm) | Temperature | Time | |
| 16.0 | | | | 13.5 | | | | 13.5 | | | |
| 12.5 | 900° C. | 1 | h | 10.6 | 900° C. | 0.5 | h | 10.6 | 900° C. | 0.5 | h |
| 9.1 | 900° C. | 1 | h | 7.6 | 900° C. | 0.5 | h | 7.6 | 900° C. | 0.5 | h |
| 6.5 | 900° C. | 0.5 | h | 5.5 | 900° C. | 0.5 | h | 5.5 | 900° C. | 0.5 | h |
| 4.7 | 900° C. | 0.5 | h | 4.0 | 900° C. | 0.5 | h | 4.0 | 900° C. | 0.5 | h |
| 3.4 | 900° C. | 0.5 | h | 2.9 | 920° C. | 60 | s | 2.9 | 920° C. | 60 | s |
| 1.8 | 920° C. | 60 | s | 1.9 | 920° C. | 40 | s | 1.9 | 900° C. | 40 | s |
| 1.3 | 920° C. | 45 | s | 1.2 | 920° C. | 40 | s | 1.2 | 920° C. | 40 | s |
| 0.86 | 920° C. | 45 | s | 0.72 | 920° C. | 30 | s | 0.72 | 920° C. | 30 | s |
| 0.57 | 920° C. | 30 | s | 0.41 | 920° C. | 30 | s | 0.41 | 920° C. | 15 | s |
| 0.20 | 920° C. | 15 | s | | | | | | | | |
| 0.040 | 920° C. | 10 | s | 0.055 | 900 to | 7 | s | 0.040 | 940° C. | 4 | s |

940° C.

TABLE 2

| D | | | | E | | | | F | | | |
|---|---|---|---|---|---|---|---|---|---|---|---|
| | Heat Treatment | | | | Heat Treatment | | | | Heat Treatment | | |
| Diameter | Conditions | | | Diameter | Conditions | | | Diameter | Conditions | | |
| (mm) | Temperature | Time | | (mm) | Temperature | Time | | (mm) | Temperature | Time | |
| 16.0 | | | | 13.5 | | | | 13.5 | | | |
| 14.8 | 900° C. | 3 | h | 12.4 | 900° C. | 2 | h | 10.6 | 900° C. | 0.5 | h |
| 12.5 | 900° C. | 3 | h | 10.6 | 900° C. | 2 | h | 7.6 | 900° C. | 0.5 | h |
| 10.7 | 900° C. | 3 | h | 9.0 | 900° C. | 2 | h | 5.5 | 900° C. | 0.5 | h |
| 9.1 | 900° C. | 2 | h | 7.6 | 900° C. | 2 | h | 4.0 | 900° C. | 0.5 | h |
| 7.7 | 900° C. | 2 | h | 6.5 | 900° C. | 2 | h | 2.9 | 920° C. | 60 | s |
| 6.5 | 900° C. | 2 | h | 5.5 | 900° C. | 2 | h | 1.9 | 900° C. | 40 | s |
| 5.6 | 900° C. | 2 | h | 4.7 | 900° C. | 2 | h | 1.2 | 920° C. | 40 | s |
| 4.7 | 900° C. | 2 | h | 4.0 | 900° C. | 2 | h | 0.72 | 920° C. | 30 | s |
| 4.0 | 900° C. | 2 | h | 3.4 | 900° C. | 2 | h | 0.41 | 920° C. | 30 | s |
| 3.4 | 900° C. | 2 | h | 2.9 | 900° C. | 2 | h | | | | |
| 2.9 | 900° C. | 2 | h | 2.5 | 900° C. | 2 | h | | | | |
| 2.5 | 900° C. | 2 | h | 2.1 | 900° C. | 1 | h | | | | |
| 2.1 | 900° C. | 2 | h | 1.8 | 900° C. | 1 | h | | | | |
| 1.8 | 900° C. | 2 | h | 1.5 | 900° C. | 1 | h | | | | |
| 1.5 | 900° C. | 2 | h | 1.1 | 900° C. | 1 | h | | | | |
| 1.3 | 900° C. | 2 | h | 0.79 | 900° C. | 1 | h | | | | |
| 1.0 | 900° C. | 2 | h | 0.57 | 900° C. | 1 | h | | | | |
| 0.73 | 900° C. | 2 | h | 0.35 | 920° C. | 3 | min | | | | |
| 0.53 | 900° C. | 2 | h | 0.17 | 920° C. | 2 | min | | | | |
| 0.32 | 920° C. | 3 | min | 0.081 | 920° C. | 60 | s | | | | |
| 0.16 | 920° C. | 2 | min | | | | | | | | |
| 0.075 | 920° C. | 60 | s | | | | | | | | |
| 0.040 | 930° C. | 5 | s | 0.055 | 930° C. | 5 | s | 0.040 | 900° C. | 2 | h |

The wire of each of the produced samples is a round wire. The diameter of each of the wires of samples No. 1, No. 15, No. 5, No. 11, and No. 13 produced under condition A, condition C, condition D, or condition F was 40 μm. The diameter of each of the wires of samples No. 2, No. 3, No. 4, No. 6, No. 14, and No. 12 produced under condition B or condition E was 55 μm.

### (Ratio of Coverage of Shell)

The ratio of coverage of the shell in the wire of each sample was found. A cross sectional area S₁ of the wire and a cross sectional area S₃ of the shell in the transverse cross section of the wire were measured. The ratio of coverage was calculated as (S₃/S₁)×100. The ratio of coverage of the shell in each sample is shown in Table 3.

### (Thickness of Precipitation Layer)

The thickness of the precipitation layer in the wire of each sample was measured. The thickness of the precipitation layer was measured as follows. A longitudinal cross section of the wire is taken and the cross section of the shell is observed by an SEM. In the cross section of the shell, a vicinity of the outer peripheral surface of the shell is observed at a magnification of 20,000 times. Five regions of the outer peripheral surface of the shell are selected from this observation visual field. Each of the selected regions is observed at a magnification of 100,000 times. It is determined whether or not a precipitate is present in the observation visual field. The observation visual field is scrolled from the outer peripheral surface of the shell toward the center of the shell until no precipitate is present in the observation visual field. A distance to a precipitate present at a position farthest away from the outer peripheral surface of the shell is measured. The same operation is performed for each of the other selected regions, and a distance to a precipitate present at a position farthest away from the outer peripheral surface of the shell is measured. The average value of the measured distances is regarded as the thickness of the precipitation layer. The thickness of the precipitation layer in each sample is shown in Table 3.

The average crystal grain size of the shell in the wire of each sample was measured. The average crystal grain size of the shell was measured by the method described in the above-described section <Average Crystal Grain Size of Shell>.

### (Mechanical Properties)

The mechanical properties of the wire of each sample were evaluated. Specifically, the tensile strength and the elongation were measured.

The tensile strength and elongation of the wire were measured as follows. The wire was cut to produce a test piece having a length of 100 mm. A tensile strength when the test piece was broken by pulling the test piece at a pulling rate of 50 mm/min was regarded as the tensile strength of the wire. On the other hand, the elongation of the wire is the following value expressed in percent: a value obtained by measuring the length of the test piece at the time of breaking and dividing, by the length of the test piece before pulling, a value obtained by subtracting the length of the test piece before pulling from the length at the time of breaking. The tensile strength and elongation of the wire of each sample are shown in Table 3.

### (Electric Conductivity)

Further, the electric conductivity of the wire of each sample was measured. Measurement results are shown in Table 3.

TABLE 3

| | | Thickness of | | | | Average |
|---|---|---|---|---|---|---|
| | Ratio of | Precipitation | Tensile | | Electric | Crystal |
| Sample | Coverage | Layer | Strength | Elongation | Conductivity | Grain Size |
| No. | (%) | (μm) | (MPa) | (%) | (% IACS) | (μm) |
| 1 | 50 | 0.4 | 710 | 17.6 | 53.8 | 0.5 |
| 2 | 65 | 0.3 | 896 | 15.7 | 38.0 | 0.4 |
| 3 | 65 | 0.3 | 862 | 20.4 | 37.8 | 0.6 |
| 4 | 75 | 0.3 | 980 | 15.6 | 27.0 | 0.5 |
| 5 | 75 | 0.2 | 947 | 23.7 | 27.2 | 0.8 |
| 6 | 90 | 0.3 | 1118 | 17.4 | 10.6 | 0.5 |
| 11 | 50 | 2.8 | 713 | 8.6 | 54.2 | 0.6 |
| 12 | 65 | 2.3 | 862 | 9.8 | 37.6 | 0.6 |
| 13 | 75 | 1.9 | 967 | 11.6 | 27.0 | 8.2 |
| 14 | 40 | 0.3 | 590 | 17.4 | 65.3 | 0.6 |
| 15 | 95 | 0.4 | 1193 | 15.6 | 4.9 | 0.5 |

Each of the wires of samples No. 1 to No. 6 has an elongation of 12% or more and is excellent in elongation property. Further, each of the wires of samples No. 1 to No. 6 has a tensile strength of 600 MPa or more and 700 MPa or more, and has both a high tensile strength and a high elongation. In each of the wires of samples No. 1 to No. 6, the thickness of the precipitation layer was 1.0 μm or less and 0.5 μm or less. The average crystal grain size of each of the wires of samples No. 1 to No. 6 was 0.8 μm or less. In the case of each of samples No. 1, No. 2, No. 4, and No. 6, the average crystal grain size is 0.5 μm or less. On the other hand, each of the wires of samples No. 11 to No. 13 has an elongation of less than 12% and is inferior in elongation property to each of the wires of samples No. 1 to No. 6. In each of the wires of samples No. 11 to No. 13, the thickness of the precipitation layer is more than 1.0 μm. In view of this result, it is considered that the thickness of the precipitation layer adversely affects the elongation property of the wire. Further, it is understandable that by controlling the thickness of the precipitation layer to be 1.0 μm or less, it is possible to effectively suppress decreased elongation property. In the wire of sample No. 14, the thickness of the precipitation layer is comparable to that of each of the wires of samples No. 1 to No. 6 and the elongation thereof is also comparable to that of each of the wires of samples No. 1 to No. 6, i.e., is 12% or more; however, the tensile strength did not reach 590 MPa and 600 MPa because the ratio of coverage was low to be 40%. In the wire of sample No. 15, the thickness of the precipitation layer is comparable to that of each of the wires of samples No. 1 to No. 6 and the elongation thereof is also comparable to that of each of the wires of samples No. 1 to No. 6, i.e., is 12% or more; however, the electric conductivity was low to be 4.9% IACS because the ratio of coverage was high to be 95%.

The thickness of the precipitation layer in each of samples No. 1 to No. 6 could be suppressed to be 1.0 μm or less presumably because the heat treatment conditions were controlled. In each of samples No. 1 to No. 6, as shown in conditions A to C in Table 1, the temperatures of all the intermediate heat treatments were each controlled to be 850° C. or more and 960° C. or less, and the time of each of all the intermediate heat treatments was controlled to be less than 2 hours, particularly, 1 hour or less. Further, in each of samples No. 1 to No. 6, the number of times of performing the intermediate heat treatment is 20 times or less and 15 times or less. In particular, in each of samples No. 1 to No. 6, the number of times of performing the heat treatment for one hour or more is small. Specifically, the number of times of performing the intermediate heat treatment for one hour or more is 5 times or less, and 3 times or less. In condition A of the heat treatment performed onto sample No. 1, the number of times of performing the intermediate heat treatment for one hour is two. In condition B or condition C of the heat treatment performed onto each of samples No. 2 to No. 6, the time of each of all the intermediate heat treatments is less than 1 hour and 0.5 hour or less. Similarly, in each of sample No. 14 having been through the heat treatment under condition B for sample No. 2 and sample No. 15 having been through the heat treatment under condition A for sample No. 1, the thickness of the precipitation layer could be suppressed to be 1.0 μm or less. On the other hand, in each of samples No. 11 and No. 12, the thickness of the precipitation layer was large presumably because the intermediate heat treatment for 2 hours or more was performed one or more times as shown in conditions D and E in Table 2. In each of samples No. 11 and No. 12, the number of times of performing the intermediate heat treatment for one hour or more was 10 or more, and 15 or more. Further, in each of samples No. 11 and No. 12, the number of times of performing the intermediate heat treatment for two hours or more is two or more. In sample No. 13, the thickness of the precipitation layer and the average crystal grain size of the shell were large presumably because the time of the final heat treatment was 2 hours as shown in condition F of Table 2. It should be noted that the mechanical properties of the wires of samples No. 2 and No. 3 are different presumably because the temperature of the final heat treatment is different therebetween in the range of 900° C. to 940° C.

In addition, the following matters can be found from these test results.

(1) In view of results of comparison among samples No. 1 to No. 6, it is understandable that as the ratio of coverage of the shell is smaller, the electric conductivity of the wire is higher. This is due to the following reason: as the ratio of coverage of the shell is smaller, the area ratio of the core is increased in the transverse cross section of the wire.

(2) In view of results of comparison among samples No. 2, No. 4, and No. 6 for which the same heat treatment conditions were used, it is understandable that as the ratio of coverage of the shell is larger, the tensile strength is higher. This is due to the following reason: as the ratio of coverage of the shell is larger, the area ratio of the shell in the transverse cross section of the wire is increased.

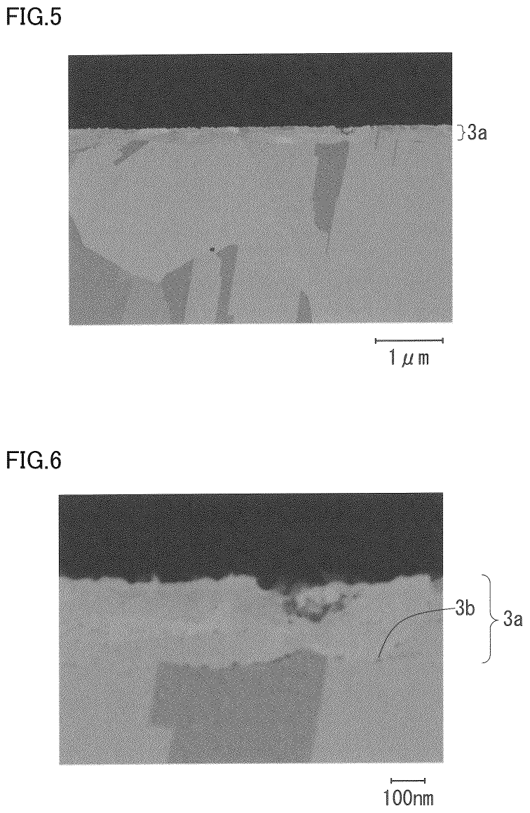

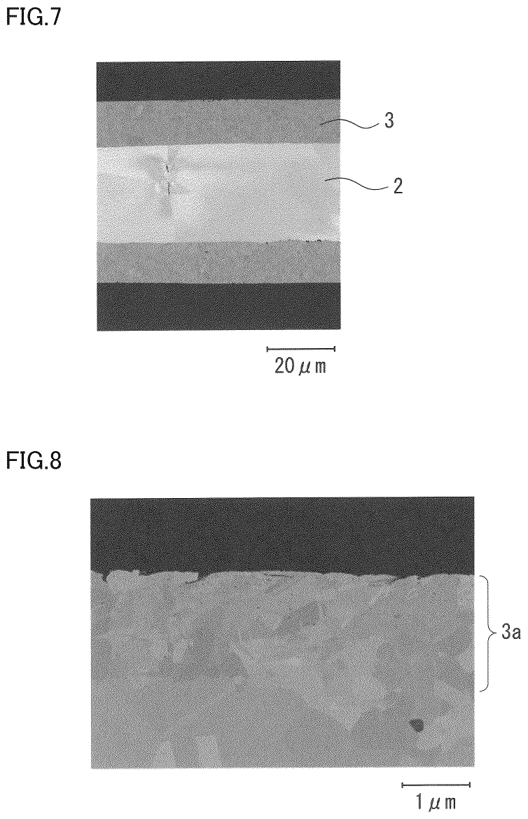

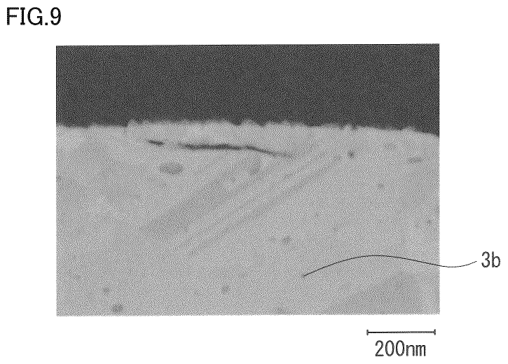

Two wires were produced by changing the conditions of the intermediate heat treatment and the final heat treatment. Of the two wires, one is a sample A and the other is a sample B. When the elongation of the wire of each sample was measured, the elongation of sample A was 29.3%. The elongation of sample B was 11.6%. FIG. 4 shows an SEM image of a longitudinal cross section of the wire of sample A as observed at a magnification of 1,000 times. In the SEM image of FIG. 4, core 2 is represented by a light-gray-colored central portion, and shell 3 is represented by dark-gray-colored portions that sandwich core 2 from above and below. Black-colored portions above and below shell 3 are background. The same also applies to an SEM image of FIG. 7. FIG. 5 shows an SEM image of a vicinity of the outer peripheral surface of shell 3 as observed at a magnification of 20,000 times in the longitudinal cross section of the wire of sample A. Shell 3 is represented by a lower dark-gray-colored portion in FIG. 5, and an upper black-colored portion is background. The same applies to each of SEM images of FIGS. 6, 8, and 9. FIG. 6 shows an SEM image obtained by observing a region of the outer peripheral surface of shell 3 in the SEM image shown in FIG. 5 at a magnification of 100,000 times. FIG. 7 shows an SEM image of the longitudinal cross section of the wire of sample B as observed at a magnification of 1,000 times. FIG. 8 shows an SEM image of a vicinity of the outer peripheral surface of shell 3 as observed at a magnification of 20,000 times in the longitudinal cross section of the wire of sample B. FIG. 9 shows an SEM image obtained by observing a region of the outer peripheral surface of shell 3 in the SEM image shown in FIG. 8 at a magnification of 100,000 times. Precipitation layer 3a is shown in each of the SEM images of FIGS. 5 and 8. In each of the SEM images of FIGS. 6 and 9, a round object in the form of a particle is precipitate 3b. When the thickness of the precipitation layer in the wire of each sample was measured, the thickness of the precipitation layer of sample A was 0.27 μm, and the thickness of the precipitation layer of sample B was 1.9 μm.

### REFERENCE SIGNS LIST

1: wire; Is: stranded wire; 2: core; 3: shell; 3a: precipitation layer; 3b: precipitate; 4: insulating layer; 10: cable; 20: film; 30: shielding layer; 31: elemental wire; 40: sheath; 100: wire material; 200: core material; 300: shell material; 500: die.

1. A wire comprising: a core; and a shell that covers an outer periphery of the core, wherein
the core includes silver,
the shell includes
33.0 mass % or more and 37.0 mass % or less of nickel,
9.0 mass % or more and 10.5 mass % or less of molybdenum,
19.0 mass % or more and 21.0 mass % or less of chromium,
0.5 mass % or more and 1.2 mass % or less of titanium, and
a remainder including cobalt and an inevitable impurity,
a diameter of the wire is 100 μm or less, and
an elongation of the wire is 12% or more.

2. The wire according to claim 1, wherein in a transverse cross section of the wire, a ratio of a cross sectional area of the shell to a cross sectional area of the wire is 50% or more and 90% or less.

3. The wire according to claim 1, comprising a precipitation layer including a titanium precipitate in an outer peripheral surface of the shell, wherein
a thickness of the precipitation layer is 0.1 μm or more and 1.0 μm or less.

4. The wire according to claim 1, wherein an average crystal grain size of a metal of the shell in a longitudinal cross section of the wire is 0.1 μm or more and 5.0 μm or less.

5. The wire according to claim 1, wherein a tensile strength of the wire is 600 MPa or more.

6. The wire according to claim 1, comprising an insulating layer that covers an outer periphery of the shell.

7. A stranded wire comprising a structure in which a plurality of the wires according to claim 1 are twisted together.

8. A cable comprising:
the stranded wire according to claim 7; and
a sheath that covers an outer periphery of the stranded wire.

9. The cable according to claim 8, comprising a shielding layer between the stranded wire and the sheath.

10. A method of manufacturing the wire according to claim 1, the method comprising:
producing a wire material by fitting a core material and a shell material;
performing wire drawing onto the wire material; and
performing heat treatment onto the wire material having been through the wire drawing, wherein
in the performing wire drawing, intermediate heat treatment is performed at a temperature of 850° C. or more and 960° C. or less for less than 2 hours during the wire drawing performed a plurality of times, and the intermediate heat treatment is performed 20 times or less.
